(19) United States
(12) Patent Application Publication
(10) Pub. No.: US 2013/0334184 A1
(43) Pub. Date: Dec. 19, 2013

(54) ROTOR BALANCE DEVICE FOR LASER REMOVAL AND METHOD THEREOF

(71) Applicants: Wen-Hao Liu, Taipei City (TW); Hsu-Jung Lin, New Taipei City (TW)

(72) Inventors: Wen-Hao Liu, Taipei City (TW); Hsu-Jung Lin, New Taipei City (TW)

(21) Appl. No.: 13/524,666

(22) Filed: Jun. 15, 2012

(51) Int. Cl. B23K 26/04; B23K 26/36

(52) U.S. Cl. 219/121.81; 219/121.85

(57) ABSTRACT

The present invention provides a rotor balance device and a method thereof. The device includes a balance measurement unit and at least one laser unit. The balance measurement unit has a correcting platen for supporting the rotor and at least one sensor. The laser unit receives a sensing signal outputted by the sensor to identify at least one position to be removed on the rotor and controls a laser beam to illuminate the position to be removed. By the inventive device and method, an improved degree of balance and reduced working hours can be obtained.

### BACKGROUND OF THE INVENTION

1. Field of the Invention

The present invention relates to a rotor balance device and a method thereof, and in particular to a rotor balance device for laser removal, which has an improved degree of balance, reduced working hours and an increased efficiency of fan. Further, the present invention relates to a rotor balance method for laser removal.

2. Description of Prior Art

With the rapid advancement of high-tech industries, the performance and functions of various electronic products become more and more powerful, so that a great amount of heat generated by electronic elements of such an electronic product will be accumulated therein. Thus, a heat sink is usually provided on the electronic elements or heat-dissipating fins are provided to increase the heat-dissipating area, thereby enhancing the heat-dissipating effect to the electronic elements. However, the heat sink and the heat-dissipating fins are configured to dissipate heat by means of heat radiation, and the resultant heat-dissipating effect is limited. Thus, a heat-dissipating fan is additionally provided to dissipate the heat absorbed by the heat sink or the heat-dissipating fins, thereby increasing the heat-dissipating effect of the whole electronic product. Therefore, the heat-dissipating fan becomes an important part in a heat-dissipating module. Unfortunately, the heat-dissipating fan may generate violate noise or vibrations in its operation due to some external factors or its structure, which may negatively affect the performance of the electronic elements such as a hard disk. Thus, a rotor of the fan has to be balanced and calibrated during the production of the fan, thereby increasing the yield of the fan.

However, in a conventional method for dynamically balancing the rotor of a fan is to increase or decrease balance soil on the outer surface or inside of the rotor where unbalance is occurred. Then, the rotor has to be tested repeatedly with regard to dynamic balance until the rotor is completely balanced. In this way, the structural balance of the rotor of the fan can be well-calibrated.

Although the above method can balance the rotor of the fan, its effect is not good enough because the following five problems would be caused if the balance soil is added onto or removed from the rotor.

(I) After being used for a long period of time, the balance soil added onto the inside of the rotor may fall off to deteriorate the balance of the rotor. Even, the rotor may get jammed due to the fallen balance soil.

(II) After the balance soil on the outer surface or inside of the rotor has been used for a long period time, the water contained in the balance soil will be evaporated to increase the magnitude of unbalance of the rotor.

(III) When the magnitude of unbalance of the rotor is too large, it becomes more difficult to add balance soil on the outer surface or inside of the rotor.

(IV) In addition to the repeated steps of increasing or decreasing the balance soil, the whole fan provided with the rotor has to be continuously adjusted and tested, which takes a lot of time and makes the whole procedure more complicated.

(V) The problem that the balance soil may fall from the outer surface or the inside of the rotor is still not solved.

Therefore, it becomes an important issue for the present inventor and manufacturers in this field to solve the problems of prior art.

### SUMMARY OF THE INVENTION

In order to solve the above problems, an objective of the present invention is to provide a rotor balance device for laser removal, which has an improved degree of balance.

Another objective of the present invention is to provide a rotor balance device, which has reduced working hours and an improved efficiency of fan.

Another objective of the present invention is to provide a rotor balance method for laser removal, which is capable of generating an improved degree of balance.

Another objective of the present invention is to provide a rotor balance method for laser removal, which has reduced working hours and an improved efficiency of fan.

In order to achieve the above objectives, the present invention provides a rotor balance device for laser removal, which includes a balance measurement unit and a laser unit positioned opposite to the balance measurement unit. The balance measurement unit has a correcting platen and at least one sensor. The correcting platen is configured to support a rotor. The sensor is configured to detect a magnitude of unbalance and a phase generated during the rotation of the rotor to thereby generate a sensing signal to the laser unit. The laser unit is electrically connected to the sensor and has an output portion for outputting a laser beam. The laser unit receives the sensing signal sent from the senor to identify a position to be removed and controls the output portion to output a laser beam onto the position to be removed, thereby achieving a laser removal effect. Since the balance measurement unit and the laser unit are combined with each other to form a body, the measurement and laser removal can be achieved automatically. In this way, the rotor can be made to have an improved degree of balance, the working hours are reduced, and the efficiency of fan is improved.

The present invention further provides a rotor balance method for laser removal, which is applied to a rotor balance device comprising a balance measurement unit and at least one laser unit. The method includes steps as follows. First, a rotor is put on a correcting platen of the balance measurement unit. After the rotor is activated to rotate, at least one sensor of the balance measurement unit detects a magnitude of unbalance and a phase generated during the rotation of the rotor to thereby generate a sensing signal.

Then, the laser unit receives the sensing signal to identify a position to be removed and controls a laser beam to illuminate the position to be removed, thereby achieving a laser removal process. According to the method of the present invention, the measurement and laser removal can be achieved automatically. Further, the rotor can be made to have an improved degree of balance, the working hours are reduced, and the efficiency of fan is improved.

### BRIEF DESCRIPTION OF THE DRAWINGS

FIG. 1A is a perspective view showing a first embodiment of the present invention;

FIG. 1B is a perspective view showing the operation of the first embodiment of the present invention;

FIG. 2 is a perspective view showing another operation of the first embodiment of the present invention;

FIG. 3 is a perspective view showing a further operation of the first embodiment of the present invention;

FIG. 4 is a perspective view showing still a further operation of the first embodiment of the present invention;

FIG. 5 is a perspective view showing still a further operation of the first embodiment of the present invention;

FIG. 6 is a partially perspective view showing still a further operation of the first embodiment of the present invention;

FIG. 7A is a partially perspective view showing still a further operation of the first embodiment of the present invention;

FIG. 7B is a partially perspective view showing still a further operation of the first embodiment of the present invention;

FIG. 7C is a perspective view showing still a further operation of the first embodiment of the present invention; and

FIG. 8 is a flow chart showing a second embodiment of the present invention.

### DETAILED DESCRIPTION OF THE INVENTION

The above objectives and structural and functional features of the present invention will be described in more detail with reference to preferred embodiments thereof shown in the accompanying drawings

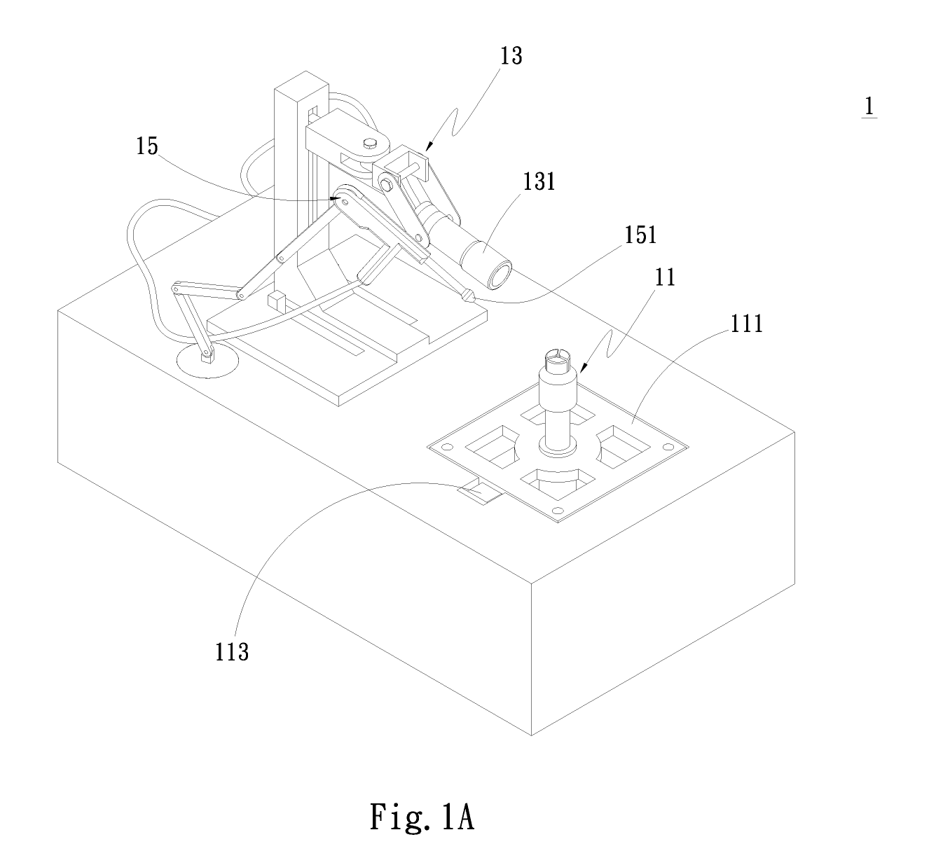

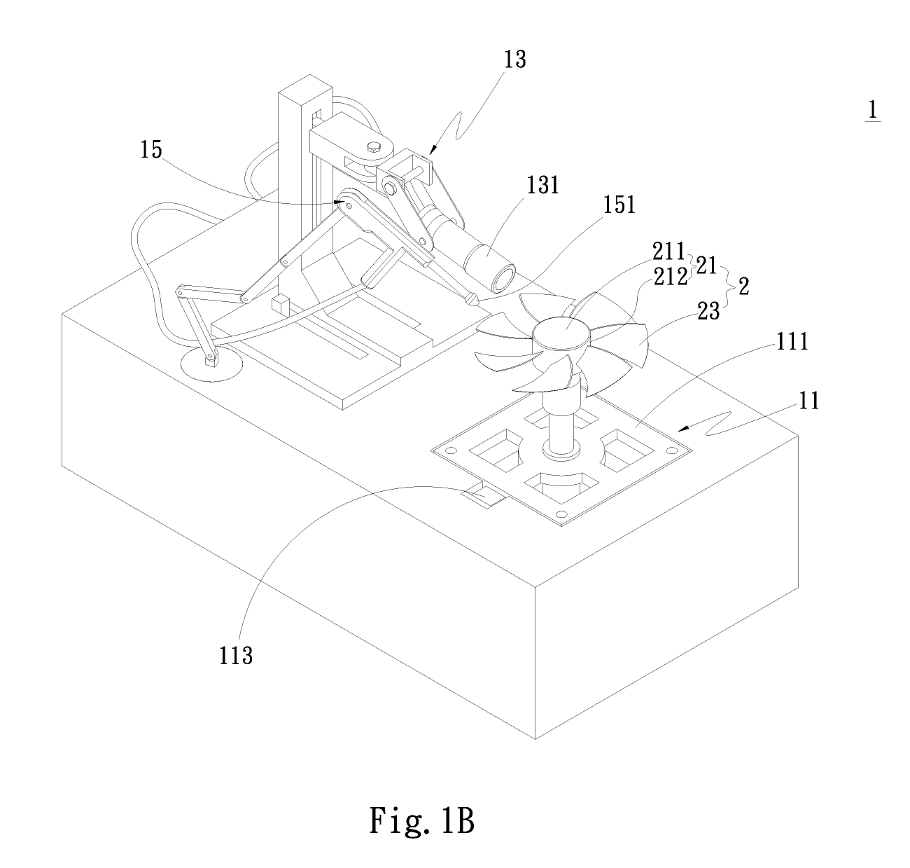

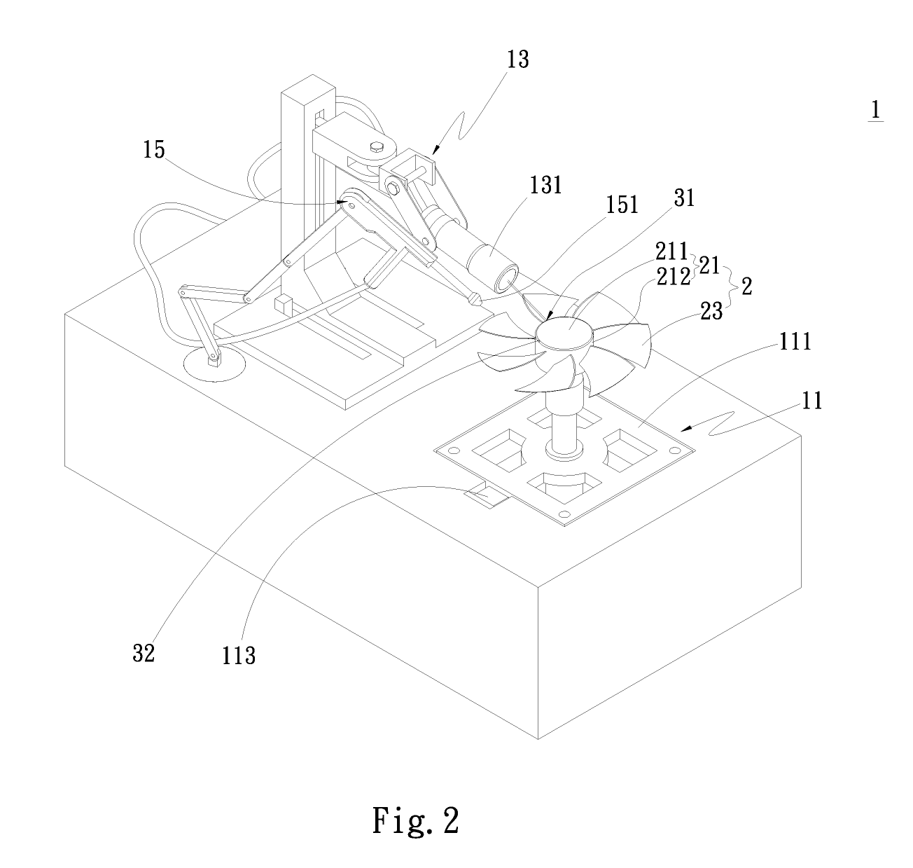

The present invention provides a rotor balance device for laser removal and a method thereof. Please refer to FIGS. 1A, 1B and 2 which are perspective views showing the first embodiment of the present invention respectively. The rotor balance device 1 includes a balance measurement unit 11, at least one laser unit 13, and an air-jetting unit 15. The balance measurement unit 11 is positioned opposite to the laser unit 13. The balance measurement unit 11 has a correcting platen 111 and at least one sensor 113. The correcting platen 111 is configured to support a rotor 2 to control the rotor 2 to rotate or not. The rotor 2 comprises a hub 21 and a plurality of blades 23 circumferentially provided on the hub 21. The hub 21 has a top portion 211 and a side portion 212 axially extending from the top portion 211.

The senor 113 is an acceleration gauge provided on one side of the correcting platen 111 and electrically connected to the laser unit 13. In a preferred embodiment, the sensor 113 is a radial acceleration gauge adhered on one side of the correcting platen 111, but it is not limited thereto. In practice, a user can choose the number of the sensors 113 on the correcting platen 111 based on a magnitude of unbalance, a phase of rotation and vibrations of the rotor 2. For example, one side of the correcting platen 111 opposite to the rotor 2 is additionally provided with an axial acceleration gauge.

The sensor 113 generates a sensing signal to the laser unit 13 based on the magnitude of unbalance and the phase of rotation of the rotor 2. The laser unit 13 is any one of a solid-state laser unit, a liquid-state laser unit and a gas-state laser unit and has an output portion 131 for outputting a laser beam.

Thus, the laser unit 13 receives the sensing signal to identify at least one position 31 to be removed on the rotor 2. The position 31 to be removed is a position on which unbalance is detected and a certain of mass is to be removed. In the present embodiment, the laser unit 13 removes a certain of mass from the rotor 2 by the following three ways without penetrating the rotor 2. In the first way, the laser unit 13 receives the sensing signal to identify that the position 31 to be removed is located on the periphery of the top portion 211 of the hub 21. Then, the output portion 131 moves and outputs a laser beam to the position 31 on the periphery of the top portion 211 of the hub 21 (FIGS. 1B to 3).

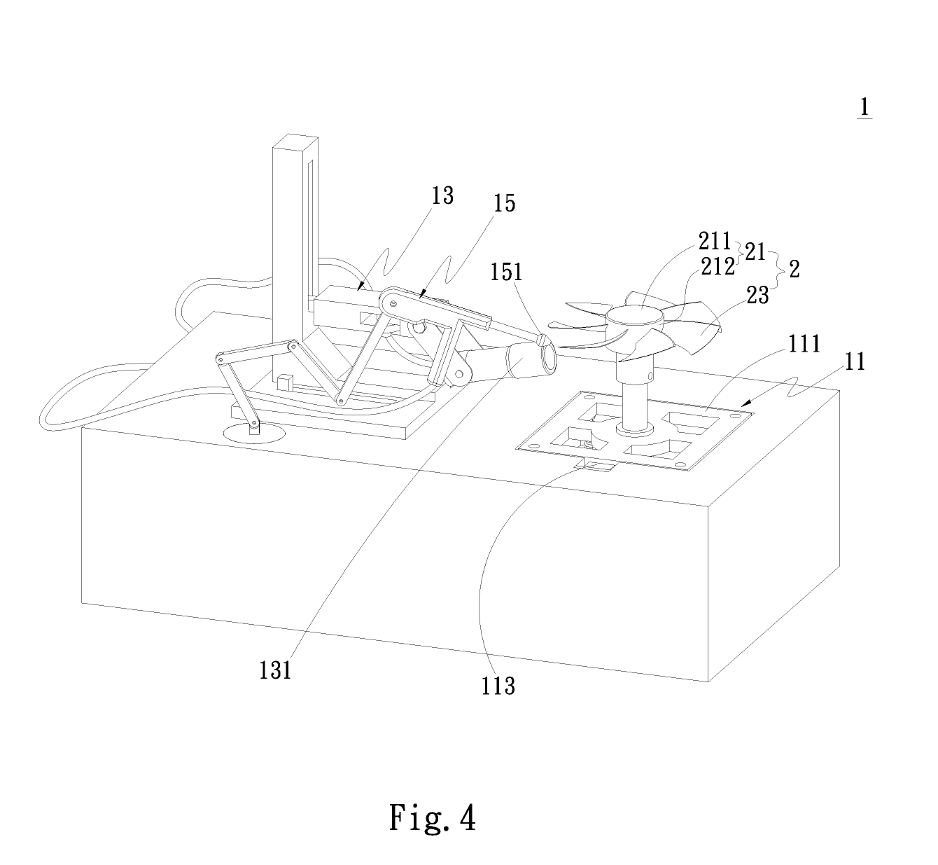

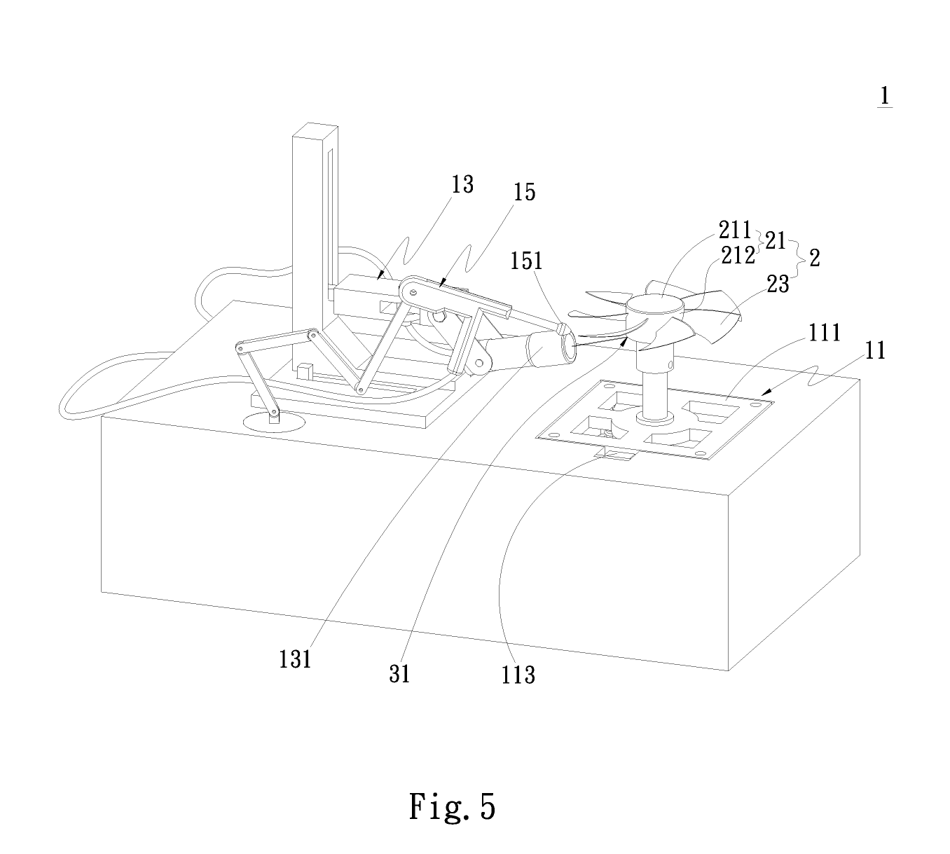

In the second way, the laser unit 13 receives the sensing signal to identify that the position 31 to be removed is located at an end of the side portion 212 of the hub 21 away from the top portion 211 (i.e. a free end of the side portion 212). Then, the output portion 131 automatically moves and outputs a laser beam to the position 31 at an end of the side portion 212 of the hub 21 away from the top portion 211 (FIGS. 4 to 6).

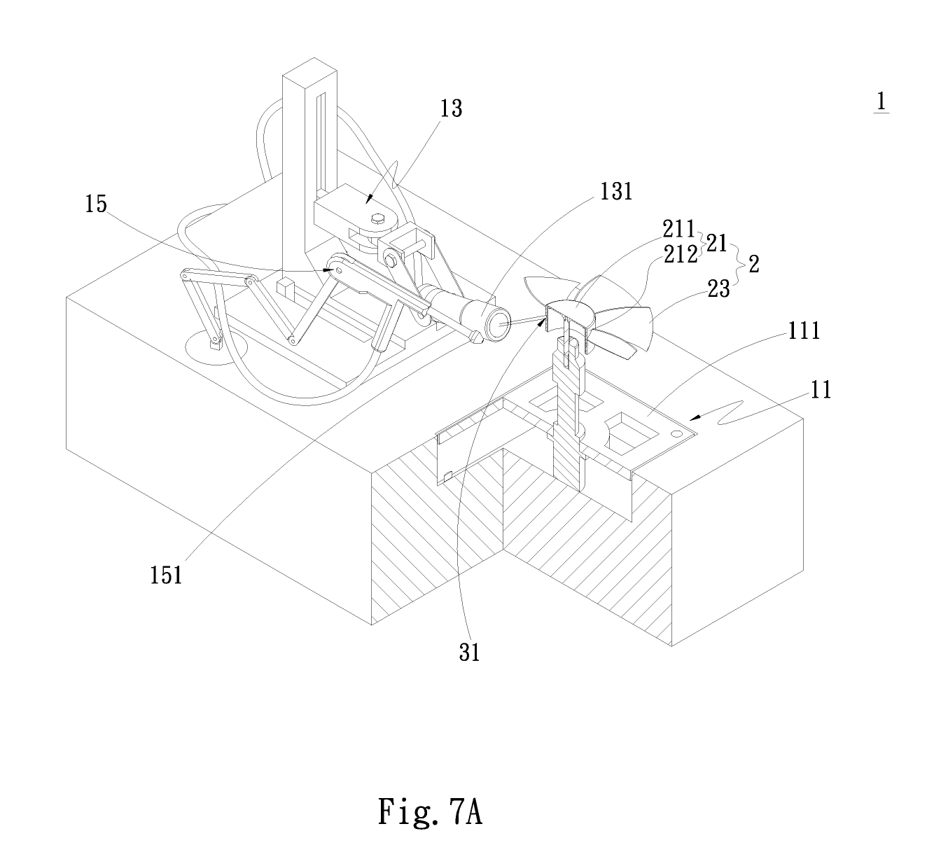

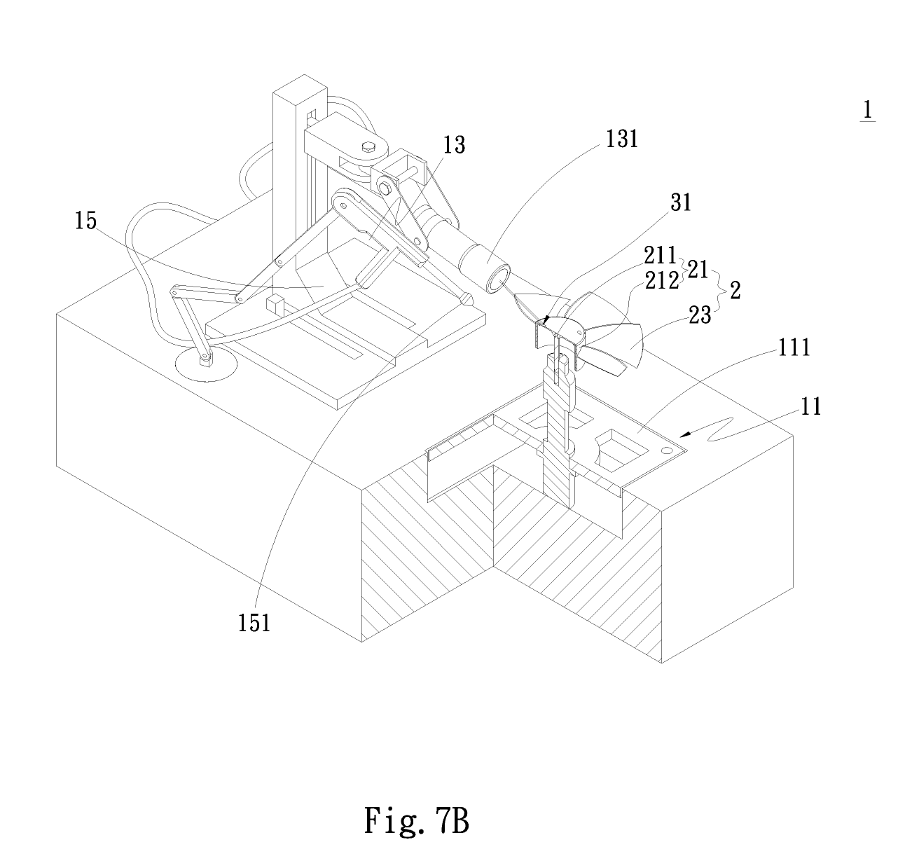

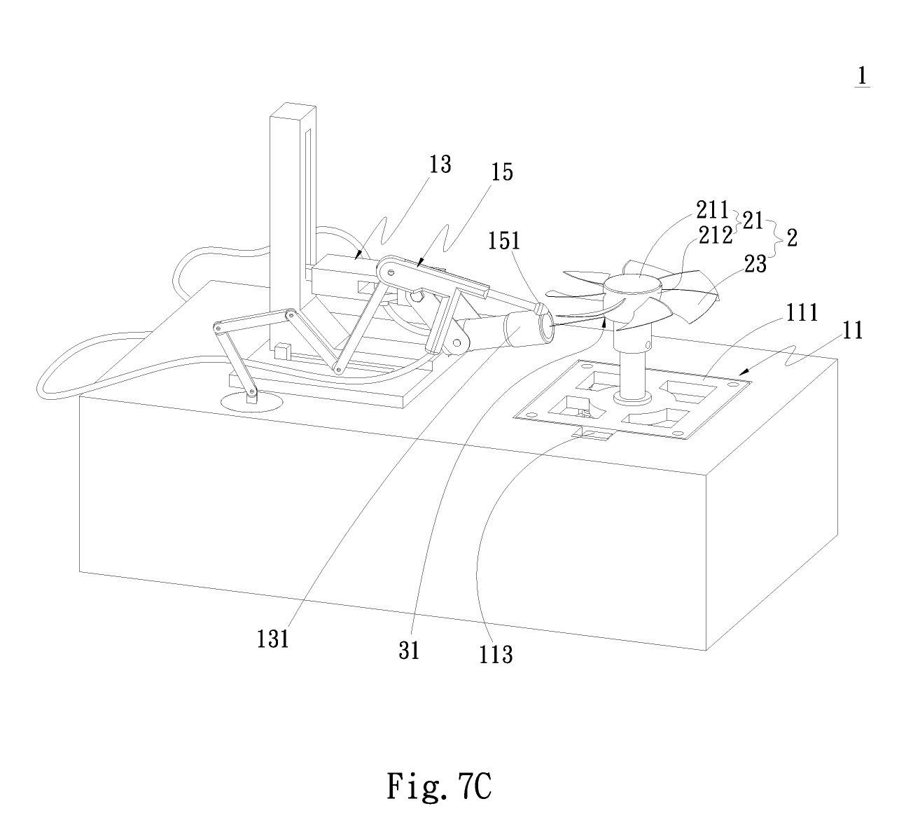

In the third way, the laser unit 13 receives the sensing signal to identify that the positions 31 to be removed are located on the periphery of the top portion 211 of the hub 21 and at an end of the side portion 212 of the hub 21 away from the top portion 211 (i.e. a free end of the side portion 212). Then, the output portion 131 automatically moves and outputs a laser beam to the positions 31 on the periphery of the top portion 211 of the hub 21 and at an end of the side portion 212 of the hub 21 away from the top portion 211 (FIG. 7). Therefore, the laser unit 13 removes a certain of mass from the rotor 2 at positions where unbalance are occurred, so that the measurement and laser removal can be achieved automatically. Further, the working hours are reduced, and the quality of balance of the rotor 2 can be improved.

It should be noted that, in practice, the ways of removing a certain of mass from the rotor 2 by the laser unit 13 are not limited to the above-mentioned three ways. The laser unit 13 may output a laser beam to an end surface on the top portion 211 of the rotor 2 (FIG. 7B) or on an outer surface of the side portion 212 (FIG. 7A), thereby removing a certain of mass from the rotor 2.

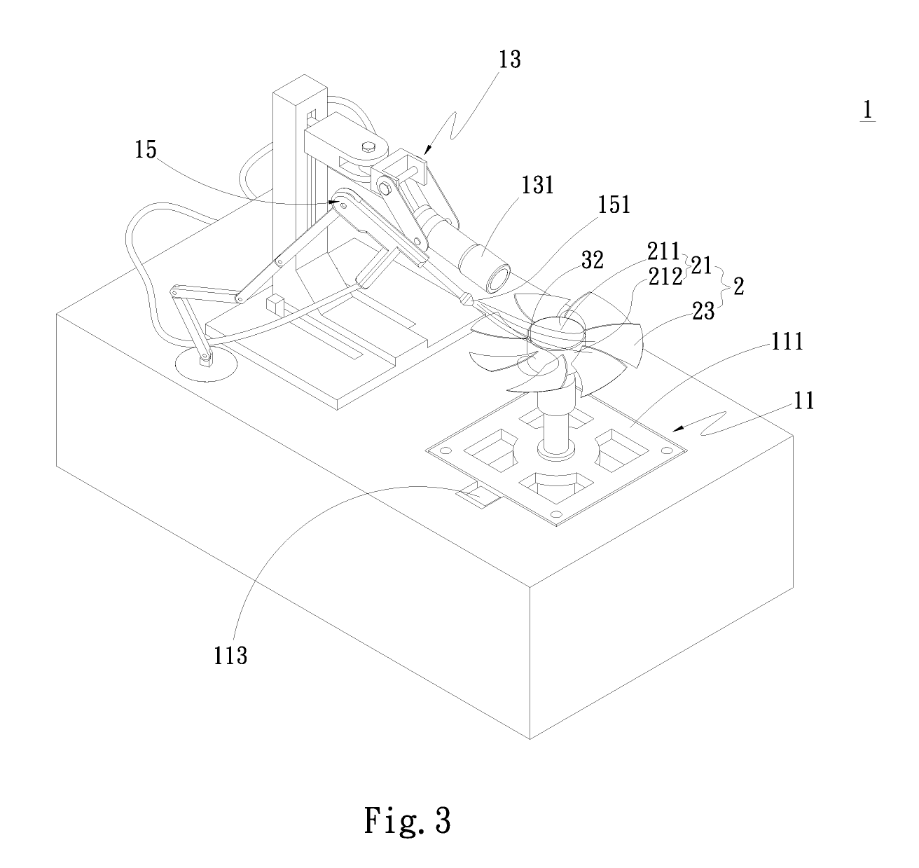

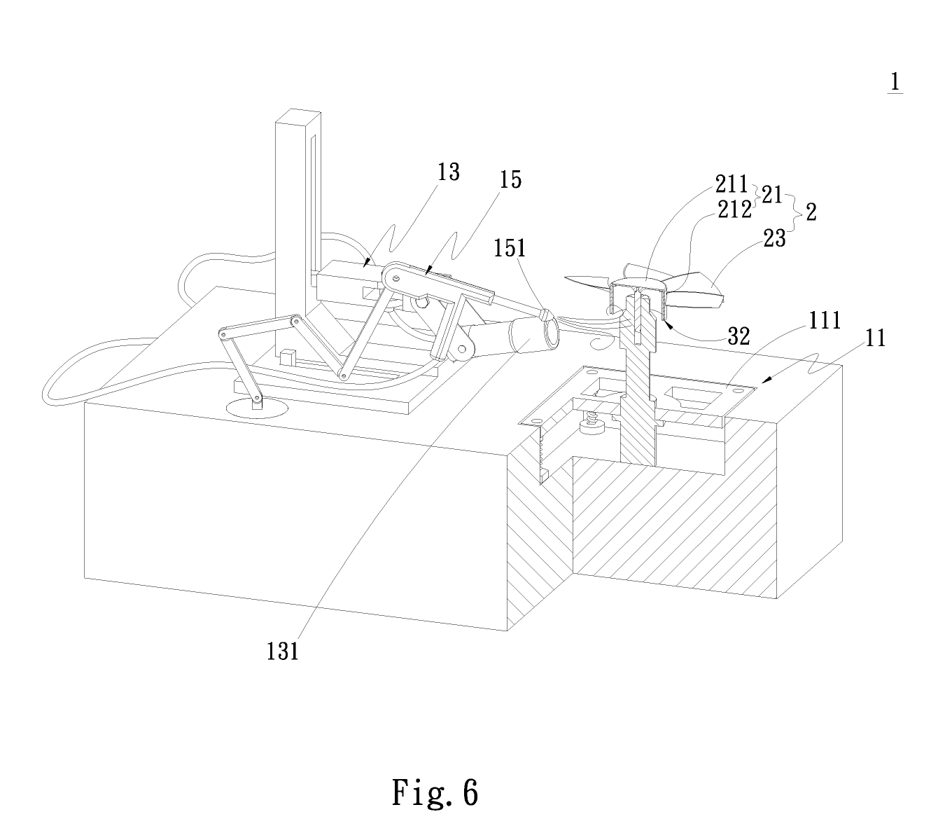

Please refer to FIGS. 3 and 6 again. The air-jetting unit 15 is an air gun positioned opposite to the balance measurement unit 11 and adjacent to the laser unit 13. The air-jetting unit 15 has a nozzle 151 for blowing off particles (such as powder) adhered onto a post-removal position 32 of the rotor 2. Thus, after the laser removal process is finished, the rotor balance device 1 automatically controls the nozzle 151 of the air gun to blow off powders on the post-removal position 32 of the rotor 2.

Please refer to FIG. 1B. In the present embodiment, the air gun, the balance measurement unit 11, and the laser unit 13 are arranged on a platen of the rotor balance device 1, but the arrangement is not limited thereto. In practice, the air gun and the laser unit 13 may be arranged on both sides of the platen of the rotor balance device 1 respectively to correspond the balance measurement unit 11.

Therefore, according to the device of the present invention, the measurement and laser removal can be achieved automatically, so that an improved degree of balance of the rotor 2 can be obtained. Further, reduced working hours and an improved efficiency of fan are achieved.

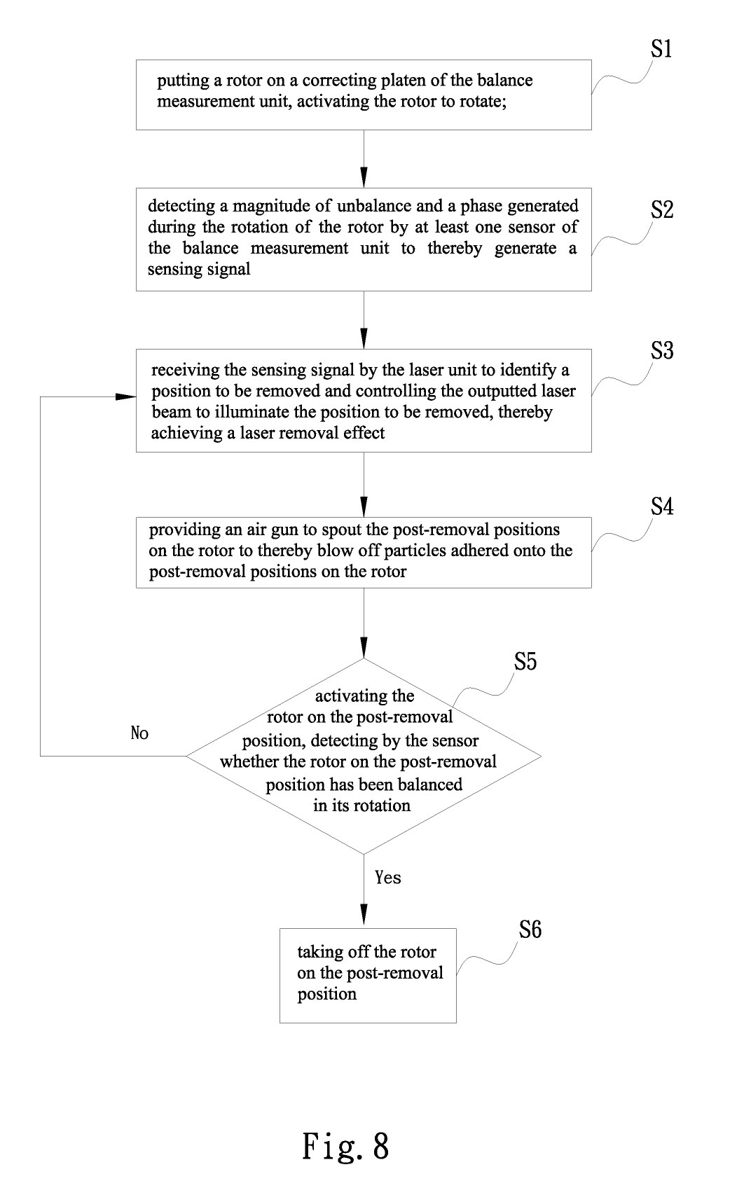

Please refer to FIG. 8, which is a flow chart showing the second embodiment of the present invention. Please also refer to FIGS. 1A to 6. The second embodiment provides a rotor balance method, which is applied to the rotor balance device 1 shown in the first embodiment. The rotor balance method includes the following steps.

(S1) Putting a rotor on a correcting platen of the balance measurement unit, activating the rotor to rotate;

In the step S1, the rotor 2 is put on the correcting platen 111 of the balance measurement unit 11. The correcting platen 111 is controlled to activate the rotor 2 to rotate (FIGS. 1A and 1B).

(S2) Detecting a magnitude of unbalance and a phase generated during the rotation of the rotor by at least one sensor of the balance measurement unit, thereby generating a sensing signal;

In the step S2, the sensor 113 of the balance measurement unit 11 is used to sense the magnitude of unbalance and the phase generated during the rotation of the rotor 2, thereby generating a sensing signal to the laser unit 13. The sensor 113 is an acceleration gauge.

(S3) Receiving the sensing signal by the laser unit to identify at least one position to be removed, controlling a laser beam outputted by the laser unit to illuminate the position to be removed, thereby completing a laser removal process.

The laser unit 13 receives the sensing signal to identify a position 31 to be removed which is located on the periphery of the top portion 211 of the hub 21 of the rotor 2 or at an end of the side portion 212 away from the top portion 211 (i.e. the free end of the side portion 212). Then, the output portion 131 is controlled automatically to output a laser beam to thereby illuminate the position 31 to be removed which is located on the periphery of the top portion 211 of the hub 21 of the rotor 2 or at an end of the side portion 212 away from the top portion 211 (i.e. the free end of the side portion 212).

(S4) Providing an air gun to blow off a post-removal position on the rotor, thereby removing particles adhered onto the rotor;

An air gun (i.e. the air-jetting unit 15) is provided on the rotor balance unit 1. After the laser unit 13 finishes the laser removal process, the rotor balance device 1 automatically controls the nozzle 151 of the air gun toward the post-removal position 32 which is located on the periphery of the top portion 211 of the hub 21 (FIG. 3) or at an end of the side portion 212 away from the top portion 211 (FIG. 6), thereby blowing off particles (such as powder) adhered onto the post-removal position 32 which is located on the periphery of the top portion 211 of the hub 21 or at an end of the side portion 212 away from the top portion 211.

(S5) Activating the rotor after removal, detecting by the sensor whether the rotor after removal is balanced. If YES, the process advances to the step S6. If NO, the process returns to the step S3.

After the air gun blows off the powders completely, the rotor balance device 1 automatically controls the correcting platen 111 of the balance measurement unit 11 to activate the rotor 2 on the post-removal position 32 (i.e. the rotor 2 after removal and correction). The sensor 113 detects whether the rotor 2 on the post-removal position 32 is balanced or not. If YES, the process advances to the step S6. If NO, the process returns to the step S3.

(S6) If the rotor is balanced, the rotor at the post-removal position is taken off

If the sensor detects that the rotor is balanced, the rotor 2 at the post-removal position 32 is corrected to become balanced. In this way, the balance measurement unit 11 can automatically controls the correcting platen 111 to thereby stop the rotation of the rotor 2 on the post-removal position 32. Then, the rotor can be taken off from the correcting platen 111.

Therefore, according to the method of the present invention, the automation of production can be achieved, so that working hours can be reduced. Further, the rotor 2 can be made to have an improved degree of balance. In this way, the efficiency of fan is improved, and the vibration is reduced.

According to the above, the present invention has following advantageous features over prior art:

(1) an improved degree of balance is obtained;

(2) the automation of production is achieved, and working hours are reduced; and

(3) the efficiency of fan is improved.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A rotor balance device for laser removal, including
a balance measurement unit having a correcting platen and at least one sensor, the correcting platen being configured to support a rotor, the sensor being arranged on one side of the correcting platen to detect a magnitude of unbalance and a phase generated during the rotation of the rotor to thereby generate a sensing signal; and
at least one laser unit positioned opposite to the balance measurement unit, the laser unit being electrically connected to the sensor and having an output portion, the laser unit receiving the sensing signal sent to identify a position to be removed and controlling the output portion to output a laser beam onto the position to be removed.

2. The rotor balance device for laser removal according to claim 1, wherein the sensor is an acceleration gauge.

3. The rotor balance device for laser removal according to claim 1, wherein the rotor comprises a hub and a plurality of blades circumferentially provided on the hub, the hub has a top portion and a side portion axially extending from the top portion, the laser unit receives the sensing signal to identify a position to be removed which is located on a periphery of the top portion of the hub or at an end of the side portion away from the top portion, the output portion is controlled to output a laser beam toward the position to be removed which is located on the periphery of the top portion of the hub or at an end of the side portion away from the top portion, thereby achieving a laser removal effect.

4. The rotor balance device for laser removal according to claim 1, wherein the rotor comprises a hub and a plurality of blades circumferentially provided on the hub, the hub has a top portion and a side portion axially extending from the top portion, the laser unit receives the sensing signal to identify positions to be removed which are located on a periphery of the top portion of the hub and at an end of the side portion away from the top portion, the output portion is controlled to output a laser beam toward the positions to be removed which are located on the periphery of the top portion of the hub and at an end of the side portion away from the top portion, thereby achieving a laser removal effect.

5. The rotor balance device for laser removal according to claim 1, wherein the laser unit is any one of a solid-state laser unit, a gas-state laser unit, and a liquid-state laser unit.

6. The rotor balance device for laser removal according to claim 1, further comprising an air-jetting unit, the air-jetting unit being configured as an air gun arranged opposite to the balance measurement unit and adjacent to the laser unit, the air jetting unit having a nozzle for blowing off particles adhered onto post-removal positions on the rotor.

7. A rotor balance method for laser removal, applied to a rotor balance device comprising a balance measurement unit and at least one laser unit, the method including steps of:
putting a rotor on a correcting platen of the balance measurement unit, activating the rotor to rotate;
detecting a magnitude of unbalance and a phase generated during the rotation of the rotor by at least one sensor of the balance measurement unit to thereby generate a sensing signal; and
receiving the sensing signal by the laser unit to identify a position to be removed and controlling the outputted laser beam to illuminate the position to be removed, thereby achieving a laser removal effect.

8. The method according to claim 7, further including a step of providing an air gun to spout the post-removal positions on the rotor to thereby blow off particles adhered onto the post-removal positions on the rotor.

9. The method according to claim 8, further including a step of activating the rotor on the post-removal position, detecting by the sensor whether the rotor on the post-removal position has been balanced in its rotation, and taking off the rotor on the post-removal position if the rotor has been balanced.

10. The method according to claim 9, wherein the method returns to the step of receiving the sensing signal by the laser unit to identify a position to be removed and controlling the outputted laser beam to illuminate the position to be removed if the rotor has not been balanced.

11. The method according to claim 7, wherein the sensor is an acceleration gauge.
